(19) United States
(12) Patent Application Publication
(10) Pub. No.: US 2025/0368576 A1
(43) Pub. Date: Dec. 4, 2025

(54) SYNERGISTIC APPROACH TO DEVELOP GAS TIGHT RESILIENT CEMENT SYSTEMS FOR LONG TERM WELLBORE INTEGRITY

(71) Applicant: SAUDI ARABIAN OIL COMPANY, Dhahran (SA)

(72) Inventors: Ashok Santra, The Woodlands, TX (US); Kenneth Dejuan Johnson, Tomball, TX (US); Rolando F. Martinez, Katy, TX (US)

(73) Assignee: ARAMCO SERVICES COMPANY, Houston, TX (US)

(21) Appl. No.: 18/676,864

(22) Filed: May 29, 2024

(51) Int. Cl. C04B 28/04; C04B 14/04; C04B 16/06; C04B 103/00; C04B 103/22; C04B 103/40; C04B 103/50; C09K 8/467

(52) U.S. Cl. CPC C04B 28/04; C04B 14/04; C04B 16/0616; C04B 16/0675; C09K 8/467; C04B 2103/0062; C04B 2103/22; C04B 2103/40; C04B 2103/50; C04B 2201/50

(57) ABSTRACT

Cement slurries including a cement composition having a base cement, silica flour, and a cross-linked polyrotaxane additive, water, and latex. The cement composition includes the cross-linked polyrotaxane additive in an amount in a range of 0.05% to 5% by weight of cement (BWOC). Cement structures formed by curing a cement slurry within a wellbore and the cement structure is located within the wellbore. Methods for cementing a wellbore, including forming a cement slurry by mixing a cement composition, water, and latex, pumping the cement slurry to a selected location within the wellbore, and curing the cement slurry at the selected location to form a cement structure.

### BACKGROUND

In well drilling processes, wellbores may be cemented, where an annulus between a casing and the wellbore is filled with cement, forming a cement sheath upon curing of the cement. A primary cement job is therefore used to support the casing and provide effective zonal isolation for the life of the well while ensuring gas flow potential (or gas migration) is minimized. To achieve this objective, the entire annulus should be filled with a competent cement/sealant that meets both short and long-term well requirements. During the well construction phase, constantly changing stresses around the borehole caused by fluctuating fluid gravity inside the wellbore influence residual stresses in the cement sheath. During the well operation phase, subsidence, depletion, and human intervention (pressure testing, perforating, fracturing, production, or injection) can cause stresses on the sealant.

Failure of the cement sheath is most often caused by pressure- or temperature-induced stresses inherent in well operations. This failure can create a path for formation fluids to enter the annulus, which can pressurize the well and render it unsafe to operate. Failure can also cause premature water production that can limit the economic life of the well. Consequently, if the cement sheath fails during its active life, the objective of producing hydrocarbons safely and economically may not be met. Therefore, the cement sheath should have optimum properties so it can withstand the stresses from well operations.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a cement slurry, including a cement composition including a base cement, silica flour, and a cross-linked polyrotaxane additive, water, and latex, where the cement composition includes the cross-linked polyrotaxane additive in an amount in a range of 0.05% to 5% by weight of cement (BWOC).

In another aspect, embodiments disclosed herein relate to a cement structure, including a cured cement slurry including a cement slurry, where the cement slurry comprises includes a cement composition having a base cement, silica flour, and a cross-linked polyrotaxane additive, water, and latex, where the cement composition includes the cross-linked polyrotaxane additive in an amount in a range of 0.05% to 5% by weight of cement (BWOC), and where the cement slurry is cured within a wellbore and the cement structure is located within the wellbore.

In yet another aspect, embodiments disclosed herein relate to a method for cementing a wellbore, including forming a cement slurry by mixing a cement composition including a base cement, silica flour, and a cross-linked polyrotaxane additive, water, and latex, pumping the cement slurry to a selected location within the wellbore, and curing the cement slurry at the selected location to form a cement structure, where the cement composition includes the cross-linked polyrotaxane additive in an amount in a range of 0.05% to 5% by weight of cement (BWOC).

Other aspects and advantages of the claimed subject matter will be apparent from the following description and the appended claims.

### BRIEF DESCRIPTION OF DRAWINGS

FIG. 1 illustrates a cross-linked polyrotaxane additive according to one or more embodiments.

FIG. 2 illustrates a method for cementing a wellbore according to one or more embodiments.

### DETAILED DESCRIPTION

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a fluid sample” includes reference to one or more of such samples.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope of the invention should not be considered limited to the specific arrangement of steps shown in the flowcharts.

Although multiply dependent claims are not introduced, it would be apparent to one of ordinary skill that the subject matter of the dependent claims of one or more embodiments may be combined with other dependent claims.

As used in this disclosure, a “cement” is a binder, for example, a substance that sets and forms a cohesive mass with measurable strengths. A cement can be characterized as non-hydraulic or hydraulic. Non-hydraulic cements (for example, Sorel cements) harden because of the formation of complex hydrates and carbonates, and may require more than water to achieve setting, such as carbon dioxide or mixtures of specific salt combinations. Additionally, too much water cannot be present, and the set material must be kept dry in order to retain integrity and strength. A non-hydraulic cement produces hydrates that are not resistant to water. Hydraulic cements (for example, Portland cement) harden because of hydration, which uses only water in addition to the dry cement to achieve setting of the cement. Cement hydration products, chemical reactions that occur independently of the mixture's water content, can harden even underwater or when constantly exposed to wet weather. The chemical reaction that results when the dry cement powder is mixed with water produces hydrates that are water-soluble. Any cement can be used in the compositions of the present application.

As used in this disclosure, the term “set” or “cure” may mean the process of a fluid slurry (for example, a cement slurry) becoming a hard solid. Depending on the composition and the conditions, it can take just a few minutes up to 72 hours or longer for some cement compositions to initially set.

As used in this disclosure, the term “polymer” can refer to a molecule having at least one repeating unit and can include copolymers or terpolymers.

“Mechanical properties” of cement refer to the properties that contribute to the overall behavior of the cement when subjected to an applied force, such as the frequent stresses cement is exposed to that impact its ability to both protect the casing and maintain zonal isolation. Mechanical properties of cement include compressive strength, elastic strength, or the elastic modulus (that is, Young's modulus), Poisson's ratio (the ratio of lateral strain to longitudinal strain in a material subjected to loading), and tensile strength.

The term “compressive strength” or “compression strength” refers to the measure of the cement's ability to resist loads which tend to compress it or reduce size. Cement composition compressive strengths can vary from 0 psi to over 10,000 psi (0 to over 69 MPa). Compressive strength is generally measured at a specified time after the composition has been mixed and at a specified temperature and pressure. In some embodiments, compressive strength is measured by a non-destructive method that continually measures correlated compressive strength of a cement composition sample throughout the test period by utilizing a non-destructive sonic device. For example, compressive strength of a cement composition can be measured using the non-destructive method according to ANSI/API Recommended Practice 10-B2 at a specified time, temperature, and pressure.

“Resiliency,” as used in this disclosure, describes the ability of the cement to resist permanent deformation when force is applied. Elastic strength is also referred to as Young's modulus. “Improved resiliency” means a decrease in the Young's modulus of the cement or cement composition being referred to.

The term “tensile strength,” as used in this disclosure, describes the ability of the cement to resist breaking while being subjected to tension forces. “Improved tensile properties” means an increase in the tensile strength of the cement or cement composition being referred to.

As used in this disclosure, “zonal isolation” means the prevention of fluids, such as water or gas, in one zone of a well or subterranean formation, from mixing with oil in another zone.

The term “downhole,” as used in this disclosure, can refer to under the surface of the earth, such as a location within or fluidly connected to a wellbore.

As used herein, the term “polyrotaxane” refers to a compound having cyclic molecules, a linear molecule included in the cyclic molecules such that the linear molecule is threaded through the cyclic molecules. In some embodiments, there are stopper groups disposed at both ends of the linear molecule so as to prevent the cyclic molecules from separating from the linear molecule. The cyclic molecules can move along the axle.

A “cross-linked polyrotaxane” or “cross-linked polyrotaxane additive” refers to a structure made up of cross-linked polyrotaxane polymers.

Embodiments in accordance with the present disclosure generally relate to cement compositions, cement slurries, and cement structures that have desired mechanical properties, resiliency, and anti-gas migration properties for long term wellbore integrity.

The cement compositions, cement slurries, and cement structures of one or more embodiments may be used as a resilient cement having a low Young's modulus and having anti-gas migration properties in oil and gas applications and may provide improved wellbore integrity over long time periods.

Cementing is one of the most important operations in both drilling and completion of the wellbore. Primary cementing occurs at least once during well construction, to secure a portion of the fluid conduit between the wellbore interior and the surface to the wellbore wall of the wellbore.

Primary cementing forms a protective solid sheath around the exterior surface of the introduced fluid conduit by positioning cement slurry in the wellbore annulus. Upon positioning the fluid conduit (such as a casing string) in a desirable location in the wellbore, introducing cement slurry into the wellbore fills at least a portion, if not all, of the wellbore annulus. When the cement slurry cures, the cement physically and chemically bonds with both the exterior surface of the fluid conduit and the wellbore wall, such as a geological formation, coupling the two. In addition, the solid cement provides a physical barrier that prohibits gases and liquids from migrating from one side of the solid cement to the other via the wellbore annulus. This fluid isolation does not permit fluid migration up-hole of the solid cement through the wellbore annulus. The cement compositions of one or more embodiments may provide one or more advantageous properties, such as resiliency, low gas migration, and good mechanical properties, for use in wellbores.

Based on case history and finite element analysis (FEA), is believed that the long-term mechanical integrity of wellbore cement sheath depends on the mechanical properties of the cement sheath, such as compressive strength and resiliency. In one or more embodiments, resiliency may be quantified by a measurement of Young's modulus, where a lower Young's modulus cement has a higher resiliency.

In one or more embodiments, higher resiliency, and therefore lower Young's modulus, of a cement structure may correlate to several advantageous properties of the cement structure. For example, higher resiliency may provide improved ability for the cement structure to survive higher stresses for a longer period of time. As another example, higher resiliency may provide a higher magnitude of deformation which the cement structure can withstand at a highest stress level before it fails. Finally, higher resiliency may correspond to a tougher cement structure, which may lead to a longer lifetime of the cement structure, where lifetime refers to the period of time before failure of the cement structure when subjected to multiple cycles of high stress environments, such as in a wellbore.

Gas flow (also known as gas migration) in oil and gas wells is defined as gases and other fluids from adjacent formations invading a cemented annulus which has not yet cured. Fluid loss in cementing operations in oil and gas wells is defined as loss of the aqueous phase into the adjacent formations from a cement slurry in the annulus that has not yet cured. In cement slurry design, fluid loss additives (i.e., fluid loss prevention additives), such as latex, may also help mitigate gas flow potential. For example, 1.5-2.0 gallons per sack (gal/sk) of a liquid latex additive may be added to a cement slurry in order to provide gas-migration control to improve durability, improve bonding, and impart acid resistant properties to the cement. The use of latex as a cement additive may help control gas migration in cement shortening the transition time between the liquid (i.e., slurry) and cured (i.e., set) state.

While providing a certain amount of resiliency to a cement composition, many fluid loss additives also increase the viscosity of the cement slurry which may cause difficulties in mixing in the field. In addition, use of high amounts of fluid loss additives in cement compositions may negatively affect mechanical properties of a cement structure formed upon curing of the cement composition.

In one or more embodiments, a polymer additive may be used in addition to a latex fluid loss additive to improve the strength of a cement composition while having minimal impact on resiliency. In one or more embodiments, the polymer additive may be a molecular toughening type additive, for example a polyrotaxane or a cross-linked polyrotaxane polymer. In one or more embodiments, a cross-linked polyrotaxane additive may be used as the polymer additive in the cement composition.

Polyrotaxane is a covalently-linked chemical structure including a linear polymer and a ring compound. The ring compound in the polyrotaxanes is a movable, cross-linked mechanical bond that allows for sliding of the polymer chains within the material. Conventional polymer additives contain permanently-linked covalent bonds that restrict motion of the polymer chains. Sliding polymer chains in the polyrotaxane structure may help to disperse stresses more equally throughout a set cement structure. In contrast, conventional polymers additives, having permanently-linked covalent bonds, may tend to break over repeated cycles of stress on the set cement structure.

The cross-linked polyrotaxane additive according to one or more embodiments may also help prevent mechanical failure of a cured cement structure by preventing the propagation of micro-cracks within the cement structure. Conventional polymer additives used in a cement structure may break under repeated stress when exposed to downhole conditions, as the stresses may be concentrated on shorter chain segments. By contrast, the cross-linked polyrotaxane additive provides a molecular toughening effect on the cement structure, which may originate from the sliding motion of polymer chains through the ring compound. The ring sliding motion may occur similarly to a pulley effect, resulting in a more uniform dispersion of stresses in the cement structure when compared to conventional polymers. Therefore, inclusion of the cross-linked polyrotaxane additive in a cement composition according to one or more embodiments may lead to improved mechanical properties, especially stiffness and may also lead to delayed failure of the cement structure under downhole conditions by delaying micro-crack propagation.

Accordingly, in one or more embodiments, latex additives, and polymer additives, for example a cross-linked polyrotaxane additive, may therefore be used in synergistic combination to provide a balance of toughness and resiliency desired for the cement sheath to survive the entire life of oil and gas wells, while at the same time combating gas migration potential.

### Cement Composition

In one aspect, embodiments disclosed herein relate to cement compositions containing a base cement, silica flour, and a cross-linked polyrotaxane additive. In some embodiments, the cement composition includes one or more additional additives selected from a fluid loss control additive, a dispersant, and a retarder.

In one or more embodiments, the cement composition includes a base cement. The base cement in the cement composition may be any suitable cement material capable of forming a cured cement structure. The cement can be any type of cement used in the construction of subterranean oil and gas wells, or any cement used in above-ground cement construction applications. In some embodiments, the cement is Portland cement. Examples of cements that can be used in the compositions include, but are not limited to Class A, Class B, Class G, and Class H cements. For example, the base cement may be a Portland cement, high alumina cement, geopolymeric cement, Sorel cement, and the like.

In one or more embodiments, the cement composition contains the base cement in an amount of from about 40% to about 90% of the total weight of the cement composition. The cement composition may contain the base cement in a range having a lower limit of any one of 40, 50, 60, 70, and 80 wt. % to an upper limit of any of 50, 60, 70, 80, and 90 wt. %, where any lower limit may be paired with any mathematically compatible upper limit.

In one or more embodiments, the cement composition includes a cross-linked polyrotaxane additive. The cross-linked polyrotaxane additive in the cement composition may be a polymer additive having molecular toughening properties. In some embodiments, polyrotaxane may contain a linear polymer and at least one ring compound, where the linear polymer is threaded through the opening of the ring compound.

In one or more embodiments, the linear polymer that can be included in the polyrotaxanes of the present disclosure can be any linear polymer that can be included in a ring compound such that the linear polymer is threaded through the opening of the ring compound. Examples of the suitable linear polymers include, but are not limited to, polyvinyl alcohol, polyvinylpyrrolidone, poly(meth)acrylic acid, cellulose resins (for example, carboxymethylcellulose, hydroxyethylcellulose, and hydroxypropylcellulose), polyacrylamide, polyethylene glycol, polypropylene glycol, polyvinyl acetal resins, polyvinyl methyl ether, polyamine, polyethyleneimine, casein, gelatin, starch, and copolymers thereof; polyolefin resins such as polyethylene and polypropylene; polyester resins; polyvinyl chloride resins; polystyrene resins such as polystyrene and acrylonitrile-styrene copolymer resins; acrylic resins such as polymethyl methacrylate, (meth)acrylate copolymers, and acrylonitrile-methyl acrylate copolymer resins; polycarbonate resins; polyurethane resins; vinyl chloride-vinyl acetate copolymer resins; polyvinyl butyral resins; polyisobutylene; polytetrahydrofuran; polyaniline; acrylonitrile-butadiene-styrene copolymers (ABS resins); polyamides such as nylon; polyimides; polydienes such as polyisoprene and polybutadiene; polysiloxanes such as polydimethylsiloxane; polysulfones; polyimines; polyacetic anhydrides; polyureas; polysulfides; polyphosphazenes; polyketones; polyphenylenes; polyhaloolefins; and derivatives of these resins. In some embodiments, the linear polymer is selected from the group consisting of a polyethylene glycol (PEG), a propylene glycol (PPG), a block copolymer of PEG and PPG, and a polysiloxane (PS). In some embodiments, the linear polymer is a PEG. In some embodiments, the linear polymer is a PS. In some embodiments, the linear polymer is selected from the group consisting of a polyethylene glycol (PEG), a propylene glycol (PPG), a block copolymer of PEG and PPG, and a polysiloxane (PS).

The linear molecules of the polyrotaxane can terminate with a functional group. In some embodiments, the functional group is selected from the group consisting of —NH₂, COOH, —OH, —CH₂═CH₂, —COCH₂(CH₃)═CH₂, —SH, —COCl, and a halide (for example, —F, —Cl, —Br, or —I). In some embodiments, the functional group is —NH₂. In some embodiments, the functional group is —COOH. In some embodiments, the linear molecule terminates on each end with the same functional group. In some embodiments, the linear molecule terminates on one end with one functional group and on the other end with a different functional group. In some embodiments, the linear molecule is a PEG that terminates with one or more —NH₂ groups. In some embodiments, the linear molecule is a polysiloxane that terminates with one or more —NH₂ groups. In some embodiments, the linear molecule is a PEG that terminates with one or more —COOH groups. In some embodiments, the linear molecule is a polysiloxane that terminates with one or more —COOH groups.

In one or more embodiments, the linear molecule has a molecular weight of about 2000 g/mol to about 50,000 g/mol. For example, the linear molecule may have a molecular weight in a range having a lower limit of any one of 2000, 5000, 10,000 and 20,000 g/mol and having an upper limit of any one of 30,000, 40,000 and 50,000 g/mol, where any lower limit may be paired with any mathematically compatible upper limit.

In one or more embodiments, polyrotaxanes include one or more ring compounds, where the linear polymer is threaded through the opening of the ring compound. The ring compound can be any ring compound that allows for threading of a linear polymer through the opening of the ring. In some embodiments, the ring compound is a cyclodextrin or cyclodextrin derivative. In some embodiments, the ring compound is a cyclodextrin or a cyclodextrin derivative. Examples of suitable ring compounds include, but are not limited to, α-cyclodextrin (α-CD), β-cyclodextrin (β-CD), γ-cyclodextrin (γ-CD), and derivatives thereof. Cyclodextrin derivatives are compounds obtained by substituting hydroxyl groups of cyclodextrin with polymer chains, substituents, or both. Examples of suitable polymer chains include, but are not limited to, polyethylene glycol, polypropylene glycol, polyethylene, polypropylene, polyvinyl alcohol, polyacrylate, polylactone, and polylactam. Examples of suitable substituents include, but are not limited to, hydroxyl, thionyl, amino, sulfonyl, phosphonyl, acetyl, alkyl groups (for example, methyl, ethyl, propyl, and isopropyl), trityl, tosyl, trimethylsilane, and phenyl.

Examples of suitable cyclodextrin and cyclodextrin derivatives include, but are not limited to, α-cyclodextrin (the number of glucose residues=6, inner diameter of opening=about 0.45 to 0.6 μm), β-cyclodextrin (the number of glucose residues=7, inner diameter of opening=about 0.6 to 0.8 μm), γ-cyclodextrin (the number of glucose residues=8, inner diameter of opening=about 0.8 to 0.95 μm), dimethyl cyclodextrin, glucosyl cyclodextrin, 2-hydroxypropyl-α-cyclodextrin, 2,6-di-O-methyl-α-cyclodextrin 6-O-α-maltosyl-α-cyclodextrin, 6-O-α-D-glucosyl-α-cyclodextrin, hexakis (2,3,6-tri-O-acetyl)-α-cyclodextrin, hexakis(2,3,6-tri-O-methyl)-α-cyclodextrin, hexakis(6-O-tosyl)-α-cyclodextrin, hexakis(6-amino-6-deoxy)-α-cyclodextrin, hexakis(2,3-acetyl-6-bromo-6-deoxy)-α-cyclodextrin, hexakis(2,3,6-tri-O-octyl)-α-cyclodextrin, mono(2-O-phosphoryl)-α-cyclodextrin, mono[2,(3)-O-(carboxylmethyl)]-α-cyclodextrin, octakis(6-O-t-butyldimethylsilyl)-α-cyclodextrin, succinyl-α-cyclodextrin, glucuronyl glucosyl-β-cyclodextrin, heptakis(2,6-di-O-methyl)-β-cyclodextrin, heptakis(2,6-di-O-ethyl)-β-cyclodextrin, heptakis(6-O-sulfo)-β-cyclodextrin, heptakis(2,3-di-O-acetyl-6-O-sulfo)β-cyclodextrin, heptakis(2,3-di-O-methyl-6-O-sulfo)-β-cyclodextrin, heptakis(2,3,6-tri-O-acetyl)-β-cyclodextrin, heptakis(2,3,6-tri-O-benzoyl)-β-cyclodextrin, heptakis(2,3,6-tri-O-methyl)β-cyclodextrin, heptakis(3-O-acetyl-2,6-di-O-methyl)-β-cyclodextrin, heptakis(2,3-O-acetyl-6-bromo-6-deoxy)-β-cyclodextrin, 2-hydroxyethyl-β-cyclodextrin, hydroxypropyl-β-cyclodextrin, 2-hydroxypropyl-β-cyclodextrin, (2-hydroxy-3-N,N,N-trimethylamino)propyl-β-cyclodextrin, 6-O-α-maltosyl-β-cyclodextrin, methyl-β-cyclodextrin, hexakis(6-amino-6-deoxy)-β-cyclodextrin, bis(6-azido-6-deoxy)-β-cyclodextrin, mono(2-O-phosphoryl)-β-cyclodextrin, hexakis[6-deoxy-6-(1-imidazolyl)]-β-cyclodextrin, monoacetyl-β-cyclodextrin, triacetyl-β-cyclodextrin, monochlorotriazinyl-β-cyclodextrin, 6-O-α-D-glucosyl-β-cyclodextrin, 6-O-α-D-maltosyl-β-cyclodextrin, succinyl-β-cyclodextrin, succinyl-(2-hydroxypropyl)β-cyclodextrin, 2-carboxymethyl-β-cyclodextrin, 2-carboxyethyl-β-cyclodextrin, butyl-β-cyclodextrin, sulfopropyl-β-cyclodextrin, 6-monodeoxy-6-monoamino-β-cyclodextrin, silyl[(6-O-t-butyldimethyl)2,3-di-O-acetyl]-β-cyclodextrin, 2-hydroxyethyl-γ-cyclodextrin, 2-hydroxypropyl-γ-cyclodextrin, butyl-γ-cyclodextrin, 3A-amino-3A-deoxy-(2AS,3AS)-γ-cyclodextrin, mono-2-O-(p-toluenesulfonyl)-γ-cyclodextrin, mono-6-O-(p-toluenesulfonyl)-γ-cyclodextrin, mono-6-O-mesitylenesulfonyl-γ-cyclodextrin, octakis(2,3,6-tri-O-methyl)-γ-cyclodextrin, octakis(2,6-di-O-phenyl)-γ-cyclodextrin, octakis(6-O-t-butyldimethylsilyl)-γ-cyclodextrin, and octakis(2,3,6-tri-O-acetyl)-γ-cyclodextrin. The ring compounds, such as the cyclodextrins listed in the present disclosure, can be used alone or in combination of two or more.

In some embodiments, the amount of ring compound on the polymer chain is about 20 wt % to about 70 wt % of the total weight of polymer. The amount of ring compound may be in a range having a lower limit of any one of 20, 30, and 40 wt % and having an upper limit of any one of 50, 60, and 70 wt %, where any lower limit may be paired with any mathematically compatible upper limit.

The polyrotaxanes of the present disclosure that include a linear polymer and one or more ring compounds can be cross-linked with a cross-linking agent, or cross-linker, to form the cross-linked polyrotaxane additives of the present disclosure. In some embodiments, the cross-linker is selected from the group consisting of trimesoyl chloride, formaldehyde, cyanuric chloride (CC), and bisphenol A diglycidyl ether (DGE).

Examples of suitable cross-linkers include, but are not limited to, melamine resins, polyisocyanate compounds, block isocyanate compounds, cyanuric chloride, trimesoyl chloride, terephthaloyl chloride, epichlorohydrin, dibromobenzene, formaldehyde, glutaraldehyde, phenylenediisocyanate, toluene diisocyanate, divinylsulfone, bisphenol A diglycidyl ether, diisopropylethylenediamine, 1,1-carbonyldiimidazole, and alkoxy silanes. The cross-linkers can be used alone or in combination. In some embodiments, the cross-linker is selected from the group consisting of trimesoyl chloride, formaldehyde, cyanuric chloride (CC), and bisphenol A diglycidyl ether (DGE). In some embodiments, the cross-linker is diisopropylethylenediamine. In some embodiments, the cross-linker is cyanuric chloride. In some embodiments, the cross-linker is bisphenol A diglycidyl ether.

In some embodiments, the amount of cross-linker in the cross-linked polyrotaxane additive is about 1 wt % to about 10 wt % of the total weight of polymer. The amount of cross-linker may be in a range having a lower limit of any one of 1, 2, and 5 wt % and having an upper limit of any one of 7, 9, and 10 wt %, where any lower limit may be paired with any mathematically compatible upper limit.

### Polyrotaxanes and Amount of Inclusion

In some embodiments, where a plurality of ring compounds includes a linear polymer such that the linear polymer is threaded through the ring compounds, when the maximum amount of inclusion of one linear polymer in the ring compound is 1, the ring compounds can include the linear polymer in an amount of 0.001 to 0.6, such as 0.01 to 0.5, or 0.05 to 0.4.

The maximum amount of inclusion in the ring compounds can be calculated from the length of the linear polymer and the thickness of the ring compounds. For example, when the linear polymer is polyethylene glycol and the ring compounds are α-cyclodextrin molecules, the maximum amount of inclusion has been experimentally determined (see, for example, Macromolecules (1993) 26:5698-5703).

In some embodiments, the polyrotaxane includes one or two stopper groups. The stopper groups can be any group that is disposed at either or both ends of a linear polymer and act to prevent separation of the ring compounds. In some embodiments of the present disclosure, the polyrotaxane includes one or two stopper groups and is selected from α-CD-PEG-NH-DNF or γ-CD-PS-COOH-PNP. In some embodiments, the polyrotaxane with one or two stopper groups is α-CD-PEG-NH-DNF. In some embodiments, the polyrotaxane with one or two stopper groups is γ-CD-PS-COOH-PNP.

Examples of suitable stopper groups include, but are not limited to, dinitrophenyl groups, cyclodextrins, adamantane groups, trityl groups, fluoresceins, pyrenes, substituted benzenes, optionally substituted polynuclear aromatics, and steroids. Examples of substituents include, but are not limited to, alkyl groups such as methyl, alkyloxy groups such as methoxy, and hydroxy, halogen, cyano, sulfonyl, carboxyl, amino, and phenyl groups. One or more substituents can be present. In some embodiments, the stopper group is selected from the group consisting of a dinitrofluorophenyl group, a cyclodextrin, a nitrophenol, and combinations thereof. In some embodiments, the stopper group is p-nitrophenol (PNP). In some embodiments, the stopper group is 2,4-dinitrofluorobenzene (DNF).

Thus, in some embodiments, the cross-linked polyrotaxane of the present disclosure contains a linear polymer and a ring compound and is cross-linked via a cross-linker as disclosed herein.

### Method of Preparing the Cross-Linked Polyrotaxanes

### Preparing the Polyrotaxane

The reaction of threading ring compounds onto the linear polymers to form the polyrotaxane can be carried out in any suitable solvent. In some embodiments, the solvent is selected from the group consisting of water, methanol, ethanol, and combinations thereof. In some embodiments, the concentration of the linear polymer and the ring compound in the solvent is about 5 wt % to about 50 wt %. The concentration of the linear polymer and the ring compound in the solvent may be in a range having a lower limit of any one of 5, 10, and 25 wt % and having an upper limit of any one of 30, 40, and 50 wt %, where any lower limit may be paired with any mathematically compatible upper limit. In some embodiments, the concentration of the linear polymer and the ring compound in the solvent is about 5 wt % to about 50 wt %. In some embodiments, the concentration of the linear polymer and the ring compound in the solvent is about 15 wt % to about 35 wt %. In some embodiments, the concentration of the linear polymer and the ring compound in the solvent is about 20 wt % to about 25 wt %.

In some embodiments, the reaction of threading ring compounds onto the linear polymers to form the polyrotaxane is carried out at a reaction temperature of about 0° C. to about 80° C. For example, the reaction temperature may be in a range having a lower limit of any one of 1, 2, and 5 wt % and having an upper limit of any one of 7, 9, and 10 wt %, where any lower limit may be paired with any mathematically compatible upper limit. In some embodiments, the reaction of threading ring compounds onto the linear polymers to form the polyrotaxane is carried out at a reaction temperature of about 0° C. to about 80° C. In some embodiments, the reaction of threading ring compounds onto the linear polymers to form the polyrotaxane is carried out at a reaction temperature of about 2° C. to about 50° C. In some embodiments, the reaction of threading ring compounds onto the linear polymers to form the polyrotaxane is carried out at a reaction temperature of about 4° C. to about 25° C.

In some embodiments, the reaction of threading ring compounds onto the linear polymers to form the polyrotaxane is carried out for about 1 hour to about 24 hours, such as about 1 hour to about 18 hours, about 1 hour to about 12 hours, about 1 hour to about 5 hours, about 5 hours to about 24 hours, about 5 hours to about 18 hours, about 5 hours to about 12 hours, about 12 hours to about 24 hours, about 12 hours to about 18 hours, about 18 hours to about 24 hours, or about 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, or about 24 hours. In some embodiments, the reaction of threading ring compounds onto the linear polymers to form the polyrotaxane is carried out for about 1 hour to about 24 hours. In some embodiments, the reaction of threading ring compounds onto the linear polymers to form the polyrotaxane is carried out for about 5 hours to about 18 hours. In some embodiments, the reaction of threading ring compounds onto the linear polymers to form the polyrotaxane is carried out for about 12 hours.

The polyrotaxanes thus formed can be separated by any acceptable method, including centrifugation, filtration, and freeze drying.

### Preparing the Cross-Linked Polyrotaxane

The cross-linking of the polyrotaxanes can be carried out after drying the polyrotaxane or before drying the polyrotaxane. In some embodiments, the cross-linking reaction involves dispersing the polyrotaxane in a solvent and adding the cross-linker. Examples of suitable solvents include, but are not limited to, N,N-dimethylformamide (DMF), acetonitrile, water, and mixtures thereof.

In some embodiments, the reaction includes adding a base. For example, a base can be added before the cross-linker is added to the reaction mixture, after the cross-linker is added to the reaction mixture, or simultaneously with the addition of the cross-linker. Examples of suitable bases include, but are not limited to, alkoxides bases, such as sodium hydroxide (NaOH), and amine bases, such as triethylamine (TEA).

In some embodiments, the reaction includes adding a stopper group moiety. In some embodiments, the stopper group moiety is added before addition of the cross-linker. For example, the stopper group moiety is added to the reaction mixture with the polyrotaxane. In such embodiments, a polyrotaxane is formed that includes the stopper moiety.

In some embodiments of the reaction, the reaction occurs at room temperature. In some embodiments of the reaction, the reaction mixture is heated, for example, to reflux temperature or to about 50° C., about 60° C., about 70° C., about 80° C., about 90° C., about 100° C., or higher. In some embodiments, the reaction mixture is heated to reflux for about 8 hours. In some embodiments, the reaction mixture is heated to about 100° C. for about 2 hours.

Compositions and methods for producing a the cross-linked polyrotaxane additive according to one or more embodiments is included in more detail in U.S. Pat. Nos. 11,479,708 and 11,230,497, which are hereby incorporated by reference.

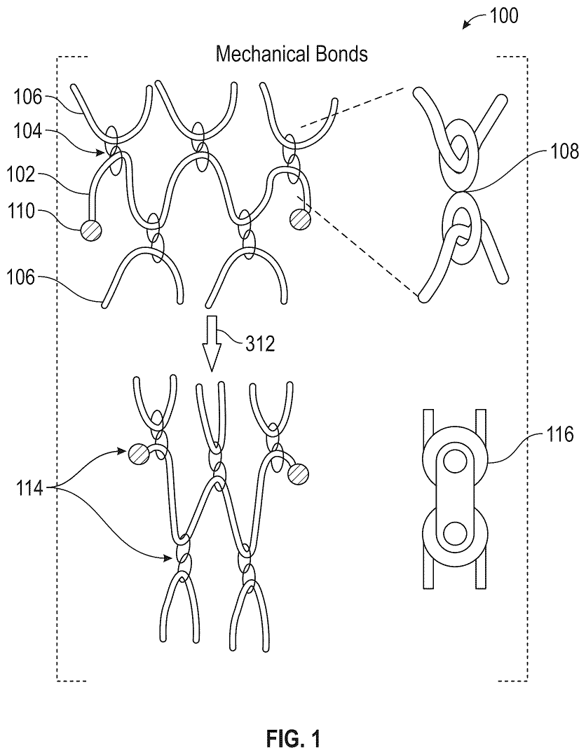

Turning now to the figures, FIG. 1 illustrates a cross-linked polyrotaxane additive 100 according to one or more embodiments, where the cross-linked polyrotaxane additive 100 has mechanical bonds. The cross-linked polyrotaxane additive 100 represents implementations of cement additives in accordance with embodiments of the present disclosure. The cement may incorporate sliding-ring polymeric additives. In the illustrated embodiment, the sliding-ring polymer includes polyrotaxanes 102 and polymer chains 106. The polyrotaxanes 102 mechanically bond via a ring-type moiety 104 to the polymer chains 106. The two rings in the ring-type moiety 104 may bond 108 to each other as either cross-linked or linked by hydrogen bonds. The bond of the polymer chains 106 with the rings of the ring-type moiety 104 may be a mechanical bond. The polyrotaxane 102 may have bulky end groups 110 to resist displacement threading release of the polyrotaxane 102 from the ring-type moiety 104.

FIG. 1 depicts stress distribution in sliding-ring polymeric additives. As stress 112 is applied to the additives in set cement, the threaded rings facilitate sliding 114 of the polyrotaxane 102 and polymer chains 106. The stress is dispersed in the polymer chains 106 such as analogous to a pulley 116 effect.

The molecular-level effects may originate from the sliding motion through threaded rings (a pulley effect) leading to generally uniform dispersion of stresses in the cement matrix. The blending of sliding-ring polymeric additives in the cement imparts improvement in cement mechanical properties such as stiffness. The addition of these additives into cement may provide at least the following two properties: (i) distribution of stresses throughout the matrix of set cement; and (ii) if microcracks in the set cement arise, the sliding motions may restrict propagation of the microcracks and thus aid in holding together the set cement. More detail related to cross-linked polyrotaxane additives and the mechanical deformation of said moieties may be found in US Patent Publication No. 2020/0325070 A1, the entirety of which is hereby incorporated by reference.

In one or more embodiments, the cement composition contains the cross-linked polyrotaxane additive in an amount of from about 0.05% BWOC to about 5% BWOC. The cement composition may contain the cross-linked polyrotaxane additive in a range having a lower limit of any one of 0.05, 0.1, 0.5, and 1% BWOC and having an upper limit of any one of 2, 4, and 5% BWOC, where any lower limit may be paired with any mathematically compatible upper limit.

According to embodiments disclosed herein, the term “by weight of cement (BWOC)” describes the amount (in percent) of a material added to cement relative to the amount of the base cement in the cement composition and can be calculated by dividing the weight of the additive by the total weight of the base precursor in the cement composition and then multiplying by 100%. “By weight of cement” may be abbreviated using the acronym BWOC.

In one or more embodiments, the cement composition includes silica flour. The silica flour in the cement composition may have a particle size in a range of from about 100 US mesh to about 325 US mesh. For example, the silica flour of one or more embodiments may have a particle size in a range having a lower limit selected from 100, 125, and 150 US mesh to an upper limit selected from 200, 300, and 325 US mesh, where any lower limit may be paired with any upper limit.

In one or more embodiments, the cement composition contains the silica flour in an amount of from about 30% BWOC to about 70% BWOC. The cement composition may contain the silica flour in a range having a lower limit of any one of 30, 35, and 40% BWOC and having an upper limit of any one of 50, 60, and 70% BWOC where any lower limit may be paired with any mathematically compatible upper limit.

In one or more embodiments, the one or more additional additives may be a fluid loss control additive. In some embodiments, the fluid loss control additive may include non-ionic cellulose derivatives such as hydroxyethylcellulose (HEC). In some embodiments, the fluid loss control additive may be a non-ionic synthetic polymer (for example, polyvinyl alcohol or polyethyleneimine). In some embodiments, the fluid loss control additive may be an anionic synthetic polymer, such as 2-acrylamido-2-methylpropane sulfonic acid (AMPS) or AMPS-copolymers. In some embodiments, the fluid loss control additive may be a copolymer, such as co-polymer of dimethyl acrylamide-AMPS. In some embodiments, the fluid loss control additive may include bentonite, which may additionally viscosify the cement slurry and may, in some embodiments, cause retardation effects.

In some embodiments, the fluid loss control additive may be any suitable polymer based fluid loss control additive known in the art. For example, the fluid loss control additive may be polyvinyl alcohol (PVA), N,N-Dimethylacrylamide/2-acrylamido-2-methylpropane sulfonic acid copolymers (NNDMA-AMPS), dimethylacetamide 2-acrylamido-2-methylpropanesulfonate copolymers (DMA-AMPS), acrylic acid N,N-Dimethylacrylamide/2-acrylamido-2-methylpropane sulfonic acid terpolymers (AA-NNDMA-AMPS), combinations thereof, and the like.

In one or more embodiments, the cement composition contains the fluid loss control additive in an amount of from about 0.1% BWOC to about 5% BWOC. The cement composition may contain the fluid loss control additive in a range having a lower limit of any one of 0.1, 0.5, 1, and 2% BWOC and having an upper limit of any one of 3, 4, and 5% BWOC where any lower limit may be paired with any mathematically compatible upper limit.

In one or more embodiments, the one or more additional additives may be a dispersant containing one or more anionic groups. For instance, the dispersant may include synthetic sulfonated polymers, lignosulfonates with carboxylate groups, organic acids, hydroxylated sugars, other anionic groups, or combinations thereof. The dispersant may render the cement slurry as more fluid-like, improving flowability and providing one or more of reduced turbulence at lesser pump rates, reduced friction pressure when pumping, reduced water content, and improved performance of fluid loss additives.

In some embodiments, the dispersant may polycarboxylate, sulfonated lignin, sulfonated naphthalene, combinations thereof, and the like.

In one or more embodiments, the cement composition contains the dispersant in an amount of from about 0.1% BWOC to about 5% BWOC. The cement composition may contain the dispersant in a range having a lower limit of any one of 0.1, 0.5, 1, and 2% BWOC and having an upper limit of any one of 3, 4, and 5% BWOC where any lower limit may be paired with any mathematically compatible upper limit.

In one or more embodiments, the one or more additional additives may be a retarder. The retarder in the cement composition may be any suitable chemical which increases the thickening time of a cement slurry. In one or more embodiments, the retarder is sugar. In one or more embodiments, the retarder is calcium sulphate. In one or more embodiments, the retarder is a copolymer or terpolymer, for example a copolymer of acrylic acid and 2-acrylamido-2-methylpropane sulfonic acid (AA-AMPS) or a terpolymer of acrylic acid, 2-acrylamido-2-methylpropane sulfonic acid and itaconic acid (AA-AMPS-IA). In some embodiments, the retarder may be sodium-lignosulfonate.

In one or more embodiments, the cement composition contains the retarder in an amount of from about 0.1% BWOC to about 5% BWOC. The cement composition may contain the retarder in a range having a lower limit of any one of 0.1, 0.5, 1, and 2% BWOC and having an upper limit of any one of 3, 4, and 5% BWOC where any lower limit may be paired with any mathematically compatible upper limit.

Cement compositions according to embodiments herein may have advantageous resiliency and mechanical properties for use in wellbores. Further, the combination of specific additives in cement compositions disclosed herein may provide low gas flow potential in addition to resiliency and good mechanical properties, which may meet long-term well requirements for zonal isolation.

### Cement Slurry

One or more embodiments also relate to a cement slurry. The cement slurry may contain water, latex, and a cement composition as discussed above. In some embodiments, the cement slurry may also include one or more slurry additives selected from a defoaming agent and a latex stabilizer.

In one or more embodiments, the cement composition includes water. The water may include at least one of fresh water, seawater, and brine. The cement slurry may contain fresh water formulated to contain various salts. The salts may include, but are not limited to, alkali metal halides and hydroxides. In one or more embodiments, brine may be any of seawater, aqueous solutions wherein the salt concentration is less than that of seawater, or aqueous solutions wherein the salt concentration is greater than that of seawater. Salts that are found in seawater may include sodium, calcium, aluminum, magnesium, potassium, strontium, and lithium salts of halides, carbonates, chlorates, bromates, nitrates, oxides, phosphates, among others. Any of the aforementioned salts may be included in brine. In one or more embodiments, the density of the cement composition may be controlled by increasing the salt concentration in the brine, though the maximum concentration is determined by the solubility of the salt. In particular embodiments, brine may include an alkali metal halide or carboxylate salt and/or alkaline earth metal carboxylate salts.

In one or more embodiments, the cement slurry contains a cement composition in an amount of from about 40% to about 90% of the total weight of the cement slurry. The cement slurry may contain the water in a range having a lower limit of any one of 40, 50, and 60 wt. % to an upper limit of any of 70, 80, and 90 wt. %, where any lower limit may be paired with any mathematically compatible upper limit.

In one or more embodiments, the cement slurry contains water in an amount of from about 5% to about 60% of the total weight of the cement slurry. The cement slurry may contain the water in a range having a lower limit of any one of 5, 15, and 30 wt. % to an upper limit of any one of 40, 50, and 60 wt. %, where any lower limit may be paired with any mathematically compatible upper limit.

In one or more embodiments, the cement slurry includes latex. The latex in the cement composition may be any latex known in the art. In one or more embodiments, the latex is a liquid latex which may be added and mixed with the water prior to mixing with the cement composition.

In one or more embodiments, the cement slurry contains the latex in an amount of from about 0.1 gal/sk to about 3 gal/sk. The cement composition may contain the latex in a range having a lower limit of any one of 0.1, 0.5, and 1 gal/sk and having an upper limit of any one of 1.5, 2, and 3 gal/sk where any lower limit may be paired with any mathematically compatible upper limit.

As used herein, the term “gallons per sack (gal/sk)” refers to a unit of measure for addition of liquid additives in a cement composition. Sack is defined as a unit of measure for Portland cement. In the United States, a sack refers the amount of cement that occupies a bulk volume of 1.0 ft³. For most Portland cement, including API classes of cement, a sack weighs 94 pounds. The sack is the basis for slurry design calculations and is often abbreviated as “sk.” A weight of liquid additive added to a cement composition may be calculated according to one or more embodiments by multiplying an amount (gal/sk) of the additive by the density (lb/gal) of the liquid additive and dividing by the standard weight of cement in a sack (94 lb/sk).

In one or more embodiments, the one or more slurry additive may be a defoaming agent. The defoaming agent in the cement composition may be any suitable chemical capable of preventing air entrapment in a cement slurry during mixing. In some embodiments, the defoaming agent may be polypropylene glycol, particulate hydrophobic silica, and a liquid diluent.

In one or more embodiments, the cement composition contains the defoaming agent in an amount of from about 0.001 gallons per sack (gal/sk) to about 0.5 gal/sk. The cement composition may contain the defoaming agent in a range having a lower limit of any one of 0.001, 0.01, and 0.1 gal/sk and having an upper limit of any one of 0.2, 0.4, and 0.5 gal/sk where any lower limit may be paired with any mathematically compatible upper limit.

In one or more embodiments, the one or more slurry additive may be a latex stabilizer. In some embodiments, the latex stabilizer may be ethoxylated nonyl phenol, oligo ethoxylated iso-dodecyl alcohol ether sulfate, and the like.

In one or more embodiments, the cement composition contains the latex stabilizer in an amount of from about 0.1 gal/sk to about 1 gal/sk. The cement composition may contain the latex stabilizer in a range having a lower limit of any one of 0.1, 0.2, and 0.3 gal/sk and having an upper limit of any one of 0.5, 0.7, and 1 gal/sk where any lower limit may be paired with any mathematically compatible upper limit.

In one or more embodiments, the cement slurry has a density in a range of about 6 to about 22 ppg. The density of the cement slurry may be in a range having a lower limit of any one of 6, 8, and 10 ppg to an upper limit of any of 12, 20, and 22 ppg, where any lower limit may be paired with any mathematically compatible upper limit.

In one or more embodiments, the cement slurry may have a fluid loss in a range of about 10 mL to about 90 mL. For example, the cement structure may have a fluid loss in a range from a lower limit of any of 10, 20, 30, and 45 mL to an upper limit of any of 50, 75, and 90 mL, where any lower limit can be used in combination with any mathematically-compatible upper limit. In some embodiments, the fluid loss of the cement structure may be in the range of about 20 mL to about 100 mL.

### Cement Structure

The cement slurry of one or more embodiments may form a cement structure through curing or solidifying. As used herein, “curing” refers to providing adequate conditions (such as humidity, temperature, and time) to allow the concrete to achieve the desired properties (such as hardness) for its intended use through one or more reactions between the water and the cement composition. Curing may be a passive step where no physical action is needed (such as cement which cures in ambient conditions when untouched). In contrast, “drying” refers to merely allowing the concrete to achieve conditions appropriate for its intended use, which may only involve physical state changes, as opposed to chemical reactions. In some embodiments, curing the cement slurry may refer be passively allowing the cement slurry to harden or cure through allowing one or more reactions between the water and the cement composition. In some embodiments, suitable curing conditions may be ambient conditions. In or more embodiments, curing may also involve actively hardening or curing the cement slurry by, for instance, introducing a curing agent to the cement slurry, providing heat or air to the cement slurry, manipulating the environmental conditions of the cement slurry to facilitate reactions between the water and the cement precursor, a combination of these, or other such means.

In one or more embodiments, curing may occur at a relative humidity of greater than or equal to 50% in the cement slurry and a temperature of greater than or equal to 50° F., for a time period of from 1 to 365 days. For example, the cement slurry may cure at a relative humidity of 50% or more, 60% or more, 70% or more, 80% or more, or 90% or more. The cement slurry may be cured at temperatures of 50° F. or more, 70° F. or more, 90° F. or more, or 110° F. or more. The cement slurry may be cured for a duration of a range from a lower limit of any of 1, 5, 10, 25, and 50 days to an upper limit of any of 100, 200, 300, and 365 days, where any lower limit can be used in combination with any mathematically-compatible upper limit.

Once the cement slurry is cured, the cured cement constitutes a cement structure. In one or more embodiments, the cement slurry is cured within a wellbore and the cement structure is located within the wellbore. The cement structure will have various properties that indicate the physical strength and flexibility of the cement structure.

For instance, Young's modulus can quantify the elasticity or stiffness of the cement structure within the wellbore and gives insight into the tensile strength of the cement structure. Poisson's ratio is a measure of transverse strain to axial strain and measures the deformation capacity of the cement structure. The greater the deformation capacity (that is, the greater Poisson's ratio) the less likely the cement structure will be damaged as temperature and pressure changes within the wellbore.

In one or more embodiments, the cement structure may have a static Young's modulus in the range of about 0.1×10⁶ psi to about 3.0×10⁶ psi at a density of 15.8 pounds per gallon (ppg). For example, the cement structure may have a Young's modulus of a range from a lower limit of any of 0.1, 0.5, and 1.0×10⁶ psi at a density of 15.8 ppg to an upper limit of any of 1.5, 2.0, and 3.0×10⁶ psi at a density of 15.8 ppg, where any lower limit can be used in combination with any mathematically-compatible upper limit.

In one or more embodiments, the cement structure may have a compressive strength of greater than 1500 psi. For example, the cement structure may have a compressive strength having an upper limit of about 3000 psi or more, 5000 psi or more, or 7000 psi or more. In some embodiments, the compressive strength of the cement structure may be in the range of about 1500 psi to about 10,000 psi. For example, the cement structure may have a compressive strength in a range having a lower limit of any of 1500, 3000 and 5000 psi to an upper limit of any of 6000, 7500, and 10,000 psi, where any lower limit can be used in combination with any mathematically-compatible upper limit.

In one or more embodiments, the cement structure may have a Poisson's ratio in a range of from about 0.10 to about 0.30. For example, the cement structure may have a Poisson's ratio having an upper limit in the range having a lower limit of any of 0.10, 0.125, and 0.15 to an upper limit of any of 0.20 and 0.30, where any lower limit can be used in combination with any mathematically-compatible upper limit.

### Method for Cementing a Wellbore

Embodiments disclosed herein also relate to methods for cementing a wellbore.

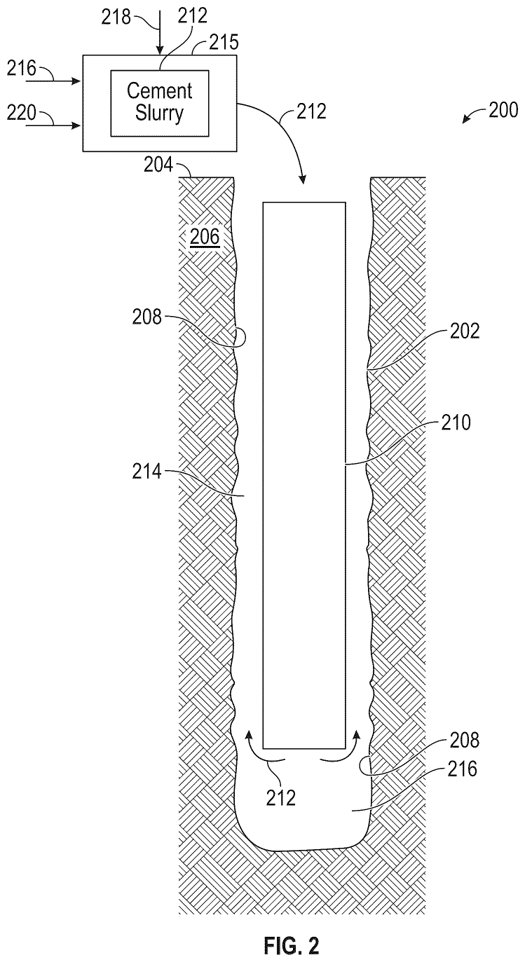

FIG. 2 illustrates a method for cementing a wellbore according to one or more embodiments. FIG. 2 shows a well site 200 including a wellbore 202 formed through the Earth surface 204 into a geological formation 206 in the Earth crust. The wellbore 202 is defined by a borehole surface 208 of the formation 206. The wellbore 202 includes a casing 210. In some implementations to cement the casing 210 in place, a cement slurry 212 is pumped down through the casing 210. The cement slurry 212 exits the bottom portion of the casing 210 and then flows upward through the annulus 214 between the casing 210 and the formation 206. The cement slurry 212 is allowed to set in the annulus 214 to cement the casing 210. This cementing of the casing 210 may be labeled as primary cementing. The cement formulations employed in the present techniques may also be utilized in secondary or remedial cementing.

Surface equipment 215 may be associated with the wellbore 202 for drilling the wellbore 202 and installation of the casing 210, and for cementing the annulus 214 between the casing 210 and the formation surface 208. The surface equipment 215 may include a vessel or truck for holding cement slurry 212. The cement slurry 212 may be prepared at the well site 200 or off-site. The method of one or more embodiments includes forming a cement slurry by mixing a cement composition 216, water 218, and cement additive(s) 220. In some implementations, the cement additives 220 may be incorporated into the cement composition 216 prior to the mixing with the water 218. The cement additives 220 may include a cross-linked polyrotaxane additive according to one or more embodiments. In some embodiments, the cement composition 216 includes the cross-linked polyrotaxane additive in an amount in a range of 0.05 to 5% by weight of cement (BWOC). In some implementations, the cement additives 220 may be a slurry additive(s), incorporated into the water 218 prior to mixing with the cement composition 216. The slurry additive(s) may include latex according to one or more embodiments.

The surface equipment 215 may include a mounted drilling rig, which may be a machine that creates boreholes in the Earth subsurface. The term “rig” may refer to equipment employed to penetrate the Earth surface 204 of Earth crust. To form a hole in the ground, a drill string having a drill bit may be lowered into the hole being drilled. In operation, the drill bit may rotate to break the rock formations to form the hole as a borehole or wellbore 202. In the rotation, the drill bit may interface with the ground or formation 206 to grind, cut, scrape, shear, crush, or fracture rock to drill the hole. The open-hole wellbore having a wall 208 with the formation 206 is drilled and formed through the Earth surface 204 into the hydrocarbon or geological formation 206.

In operation, a drilling fluid (also known as drilling mud) is circulated down the drill string (not shown) to the bottom of the openhole wellbore 202. The drilling fluid may then flow upward toward the surface through an annulus formed between the drill string and the wall 208 of the wellbore 202 as openhole. The drilling fluid may cool the drill bit, apply hydrostatic pressure upon the formation penetrated by the wellbore, and carry formation cuttings to the surface. In addition to the drilling rig, surface equipment 215 may include tanks, separators, pits, pumps, and piping for circulating drilling fluid (mud) through the wellbore.

The casing 210 may be lowered into the wellbore 202 and cement slurry 212 pumped to a selected location within the wellbore, such as to the annulus between the casing 210 and the formation surface 208 of the wellbore 202. Oil-well cementing may include mixing a slurry of cement and water, and pumping the slurry down the casing 210, tubing, or drill pipe to a specified elevation or volume in the well. As indicated, primary cementing may involve casing cementation. Primary cementing may be the cementing that takes place soon after the lowering of the casing 210 into the formation 206 and may involve filling the annulus 214 between the casing 210 and the formation 206 with cement. Upon pumping the cement slurry 212 to the selected location, the cement slurry is cured downhole at the selected location to form a cement structure.

The cement compositions, slurries, and cement structures of the present disclosure may be used in oil and gas applications. In some embodiments, the compositions and methods disclosed herein may be used in wellbores. Specifically, a cement slurry may be prepared and pumped to a chosen location within the wellbore. The cement may cure within the wellbore, forming a cement structure therewithin.

In some embodiments, cement compositions according to embodiments disclosed herein may be employed as additives in cements for oil well construction. In some embodiments, cement compositions also provide similar improvement in cements used for other construction applications, for example, construction of roads, buildings, bridges, and any other application where cement can be utilized.

### EXAMPLES

The following examples and comparative examples are provided for the purpose of further illustrating the present invention but are in no way to be taken as limiting.

The base cement used in the example cement compositions was Class G cement.

The silica flour used in the example cement compositions was SSA-1 acquired from Halliburton.

The fluid loss control additive used in the example cement compositions was Polytrol FL-24 acquired from BASF.

The dispersant used in the example cement compositions was SC-9 acquired from Economy Polymers & Chemicals.

The retarder used in the example cement compositions was PCR-3 acquired from Economy Polymers & Chemicals.

The latex used in the example cement compositions was Latex 2000 acquired from Halliburton.

The latex stabilizer used in the example cement compositions was Latex stabilizer 434 from Halliburton.

The defoaming agent used in the example cement compositions was D-air 3000 acquired from Halliburton.

The cross-linked polyrotaxane additive used in the example cement compositions was synthesized by Aramco Americas inhouse laboratory. The cross-linked polyrotaxane additive was synthesized using methods included in U.S. Pat. Nos. 11,479,708 and 11,230,497, which are hereby incorporated by reference.

### Preparation of Cement Slurry

Table 1 below shows a summary of cement slurries and comparative cement slurries prepared according to one or more embodiments. The cement slurries and comparative cement slurries were prepared by mixing the ingredients as shown in Table I according to American Petroleum Institute Recommended Practice (API RP) 10-B2.

### Comparative Example 1

Comparative example 1 is a comparative cement slurry. Comparative example 1 has a density of 15.8 ppg (pounds per gallon).

### Example 1

Example 1 is a cement slurry according to one or more embodiments. Example 1 has a density of 15.8 ppg.

### Example 2

Example 2 is a cement slurry according to one or more embodiments. Example 2 has a density of 15.8 ppg.

### Example 3

Example 3 is a cement slurry according to one or more embodiments. Example 3 has a density of 15.8 ppg.

TABLE 1

| Component, | Comparative | | | |
|---|---|---|---|---|
| grams (g) | Example 1 | Example 1 | Example 2 | Example 3 |
| Cement Class G | 595.49 | 589.28 | 588.14 | 594.32 |
| Silica Flour | 208.42 | 206.25 | 205.85 | 208.01 |
| FL-24 | 4.22 | 4.17 | 4.16 | 4.21 |
| SC-9 | 2.40 | 2.37 | 2.37 | 2.40 |
| PCR-3 | 1.00 | 1.00 | 1.00 | 1.00 |
| Cross-linked | 0 | 0 | 2.94 | 2.97 |
| polyrotaxane | | | | |
| additive | | | | |
| Latex Stabilizer | 0 | 16.63 | 16.59 | 0 |
| Latex | 0 | 83.13 | 82.97 | 0 |
| D-air 3000 | 0.58 | 0.58 | 0.58 | 0.58 |
| Water | 296.24 | 233.29 | 232.10 | 296 |

### Preparation of Test Specimens

Test specimens were prepared by pouring cement slurries into one inch by two inch cement cylinders and curing for 7 days at a temperature of 300° F. and 3,000 psi. Upon curing of a cement slurry, a cement structure is formed, and referred to as a “cured example.”

### Cured Comparative Example 1

Cured Comparative Example 1 is a comparative cement structure formed by curing Comparative Example 1.

### Cured Example 1

Cured Example 1 is a cement structure according to one or more embodiments, formed by curing Example 1.

### Cured Example 2

Cured Example 2 is a cement structure according to one or more embodiments, formed by curing Example 2.

### Cured Example 3

Cured Example 3 is a cement structure according to one or more embodiments, formed by curing Example 3.

### Testing of Specimans

Rheological and fluid loss control measurements were carried out on cured example 1 and cured example 2 using API RP 10B. Rheology was measured using a Fann 35 instrument. Fluid loss was measured using a Fann instrument fluid loss tester at a specified temperature and at 1000 psi differential pressure. A 325 mesh screen was used for a filtration test.

Table 2 shows fluid loss measurement results of Examples 1 and 2.

TABLE 2

| | Testing Temperature | | Testing Temperature | |
|---|---|---|---|---|
| | 70° F. | | 180° F. | |
| Dial Reading | Example 1 | Example 2 | Example 1 | Example 2 |
| 600 | 412 | 360 | 252 | 296 |
| 300 | 275 | 242 | 163 | 183 |
| 200 | 215 | 189 | 131 | 141 |
| 200 | 141 | 123 | 89 | 92 |
| 6 | 26 | 23 | 19 | 20 |
| 3 | 19 | 16 | 15 | 16 |
| API Fluid Loss | n/a | n/a | 40 ml | 40 ml |
| at 180° F. | | | | |

Example 1 includes 1.5 gal/sack liquid latex based anti-gas migration additive and Example 2 includes 1.5 gal/sack liquid latex based anti-gas migration additive which is mechanically reinforced by a cross-linked polyrotaxane additive (molecular machine chemistry). As shown by the fluid loss measurements in Table 2, addition of the cross-linked polyrotaxane additive into a cement slurry creates no change in fluid loss properties of the cement slurry.

Triaxial mechanical properties, including Young's modulus and compressive strength, were measured on Cured Comparative Example 1, Cured Example 1, Cured Example 2, and Cured Example 3.

Triaxial mechanical properties were measured using the non-destructive method according to ANSI/API Recommended Practice 10-B2 using New England Research (NER 300) instrument with 1500 psi confining pressure and at 100° F. Triaxial mechanical properties were measured using the same procedure as U.S. Pat. No. 11,130,900-B2, where is hereby incorporated by reference. The triaxial mechanical properties were measured using a triaxial press capable of generating confining pressures of up to 75 MPa (10,900 psi). The test equipment consisted of an axial loading system, a confining pressure supply system, and data acquisition software. The cylindrical cement samples were jacketed and placed between steel end-caps. Static mechanical properties were measured using strain gauge sensors, which were mounted on the sample to measure axial deformation and radial deformation. A series of laboratory tests were performed to examine the fatigue behavior of cement when subjected to cyclic loading under triaxial compression conditions. After the sample was placed in a triaxial cell, a confining pressure was applied. The cyclic axial load was applied in the form of triangular waveforms. Each sample was deformed over three cyclic loading series. In each cyclic loading series, a differential stress of 10 MPa was applied during the cyclic loading; various peak axial stresses were applied during cyclic loading. Because uniaxial stress was applied to the sample, this module was used to calculate Young's modulus and Poisson's ratio to measure sample strain.

TABLE 3

| Mechanical | Comparative | | | |
|---|---|---|---|---|
| Property | Example 1 | Example 1 | Example 2 | Example 3 |
| Young's | 2.32 × 10⁶ | 2.12 × 10⁶ | 1.80 × 10⁶ | 2.17 × 10⁶ |
| modulus (psi) | | | | |
| Compressive | 12,328 | 8547 | 8174 | 10,878 |
| Strength (psi) | | | | |

In general, crack initiation happens in cement structures at early axial strain deformation for sample with higher Young's modulus, indicating lower resiliency and durability under downhole thermal and/or mechanical stressful situations.

Stress versus Axial Strain (deformation) data shown Table 3 indicate the following. Cured Comparative Example 1, having no latex or cross-linked polyrotaxane additives, has very high Young's modulus (2.32×10⁶ psi) and, therefore the lowest capability to axially deform under stress compared the examples, 1-3.

Cured Example 1 includes 1.5 gal/sack liquid latex based anti-gas migration additive. Cured Example 1 has a slightly lower Young's modulus of 2.12×10⁶ psi than Cured Comparative Example 1, indicating that Cured Example 1 has a slightly higher resilience than Cured Comparative Example 1.

Cured Example 2 includes 1.5 gal/sack liquid latex based anti-gas migration additive which is mechanically reinforced by cross-linked polyrotaxane additive (molecular machine chemistry). Cured Example 2 has a Young's modulus of 1.80×10⁶ psi, the lowest Young's modulus of all samples tested. Therefore, Cured Example 2 has the highest capability to axially deform under stress compared to Cured Comparative Example 1, Cured Example 1, and Cured Example 3.

Cured Example 3 includes 0.5% BWOC cross-linked polyrotaxane additive. Cured Example 3 has a Young's modulus of 2.17×10⁶ psi, which is slightly higher than Cured Example 1 but not as high as Cured Comparative Example 1. Therefore, the resiliency of Cured Example 3 is between the resiliency of Cured Example 1 and Cured Comparative Example 1.

Table 3 also shows compressive strength of cement structures. Cured Comparative Example 1, having no latex or cross-linked polyrotaxane additives, had the highest compressive strength of all examples tested. This indicates that the addition of latex and cross-linked polyrotaxane additive to a cement structure may decrease the cement structure's compressive strength.

Cured Example 1 and Cured Example 2 contain 1.5 gal/sk latex and 1.5 gal/sk latex plus cross-linked polyrotaxane additive, respectively. The compressive strengths of Cured Example 1 and Cured Example 2 are similar and are lower than Cured Comparative Example 1 and Cured Example 3. Cured Example 3 contains no latex or latex stabilizer and has the second highest compressive strength of the examples tested. This indicates that the addition of latex and/or latex stabilizer to a cement structure may decrease the compressive strength of the cement structure.

In summary, as shown by the Young's modulus and compressive strength of Cured Example 2, a combination latex and cross-linked polyrotaxane additive at very low level (0.5% BWOC) makes the cement structure Cured Example 2 more resilient with good anti-gas migration properties without significantly impacting the compressive strength.

What is claimed:

1. A cement slurry, comprising:
a cement composition comprising a base cement, and a cross-linked polyrotaxane additive;
water; and
latex,
wherein the cement composition comprises the cross-linked polyrotaxane additive in an amount in a range of 0.05% to 5% by weight of cement (BWOC).

2. The cement slurry of claim 1, wherein the cement slurry comprises the cement composition in a range of 40 wt. % to 80 wt. %.

3. The cement slurry of claim 1, wherein the cement composition comprises the silica flour in a range of 30% to 70% BWOC.

4. The cement slurry of claim 1, wherein the cement slurry comprises the latex in a range of 0.1 to 3.0 gallons per sack (gal/sk).

5. The cement slurry of claim 1, wherein the cement composition comprises the silica flour in a range of 30% to 70% BWOC.

6. The cement slurry of claim 1, wherein the cement slurry has a fluid loss of between 20 mL and 50 mL at 180° F. when measured according to API RP 10B.

7. The cement slurry of claim 1, wherein the cement composition further comprises one or more additional additives selected from the group consisting of a fluid loss control additive, a dispersant, and a retarder.

8. The cement slurry of claim 7, wherein the cement slurry further comprises one or more slurry additives selected from the group consisting of a defoaming agent and a latex stabilizer.

9. A cement structure, comprising:
a cured cement slurry comprising a cement slurry, wherein the cement slurry comprises;
a cement composition comprising a base cement, and a cross-linked polyrotaxane additive;
water; and
latex;
wherein the cement composition comprises the cross-linked polyrotaxane additive in an amount in a range of 0.05% to 5% by weight of cement (BWOC), and
wherein the cement slurry is cured within a wellbore and the cement structure is located within the wellbore.

10. The cement structure of claim 9, wherein the cement slurry comprises the cement composition in a range of 40 wt. % to 90 wt. %.

11. The cement structure of claim 9, wherein the cement slurry comprises the latex in a range of 0.1 to 3.0 gallons per sack (gal/sk).

12. The cement structure of claim 9, wherein the cement slurry comprises the silica flour in a range of 30% to 70% BWOC.

13. The cement structure of claim 9, wherein the cured cement slurry has a Young's modulus of between 0.5×10⁶ Psi and 3.0×10⁶ Psi at a density of 15.8 ppg.

14. The cement structure of claim 9, wherein the cured cement slurry has a compressive strength of between 1500 Psi and 10,000 Psi.

15. The cement structure of claim 9, wherein the cement composition further comprises one or more additional additives selected from the group consisting of a fluid loss control additive, a dispersant, and a retarder.

16. The cement structure of claim 9, wherein the cement slurry further comprises one or more slurry additives selected from the group consisting of a defoaming agent and a latex stabilizer.

17. A method for cementing a wellbore, comprising:
forming a cement slurry by mixing;
a cement composition comprising a base cement, and a cross-linked polyrotaxane additive,
water, and
latex;
pumping the cement slurry to a selected location within the wellbore; and
curing the cement slurry at the selected location to form a cement structure,
wherein the cement composition comprises the cross-linked polyrotaxane additive in an amount in a range of 0.05% to 5% by weight of cement (BWOC).

18. The method of claim 17, wherein the cement slurry comprises the latex in a range of 0.1 to 3.0 gallons per sack (gal/sk).

19. The method of claim 17, wherein the cement structure has a Young's modulus of between 0.5×10⁶ psi and 3.0×10⁶ Psi at a density of 15.8 ppg.

20. The method of claim 17, wherein the cement structure has a compressive strength of between 1500 Psi and 10,000 Psi.
